(19) United States
(12) Patent Application Publication
(10) Pub. No.: US 2013/0095203 A1
(43) Pub. Date: Apr. 18, 2013

(54) INJECTION MOLD

(71) Applicants: Xiong-Fei Lei, New Taipei (TW); Xiao-Ping Wu, New Taipei (TW); Kun-Hsueh Chiang, New Taipei (TW)

(72) Inventors: Xiong-Fei Lei, New Taipei (TW); Xiao-Ping Wu, New Taipei (TW); Kun-Hsueh Chiang, New Taipei (TW)

(21) Appl. No.: 13/271,234

(22) Filed: Oct. 12, 2011

(51) Int. Cl. B29C 45/03

(52) U.S. Cl. 425/556

(57) ABSTRACT

An injection mold includes a male mold, a female mold engaged with the male mold to define a shaping chamber therebetween, an ejection plate mounted on the female mold, and an insert element. The female mold includes a female mold plate defining a female receiving space for receiving a female core therein, and a first insertion groove connecting with the female receiving space. The female core defines a first channel, and a plurality of slots connecting between the first channel and the shaping chamber. The insert element has a top inserted in the ejection plate and a bottom stretched in the first insertion groove to cooperate with the first channel and the slots to define a runner. An injection feeder nose is inserted in the insert element for injecting melted plastic materials into the runner so as to make the melted plastic materials flow into the shaping chamber.

### BACKGROUND OF THE INVENTION

1. Field of the Invention

The present invention generally relates to an injection mold, and more particularly to an injection mold capable of effectively saving plastic materials.

2. The Related Art

Referring to FIG. 1, a conventional injection mold 200 for molding a product (not labeled) therein generally includes a male mold 91, a female mold 92 and an ejection plate 93. The male mold 91 includes a male mold plate 911 and a male core 912 mounted in a middle of the male mold plate 911. The female mold 92 includes a female mold plate 921 and a female core 922 mounted in the female mold plate 921. A top of the female core 922 is concaved downward to form a first channel 923. The female core 922 defines a plurality of slots 924 extending vertically to penetrate through the female core 922 and connecting with a bottom of the first channel 923. A bottom of the ejection plate 93 is concaved upward to form a second channel 931 matched with the first channel 923. A top of the ejection plate 93 defines an injection hole 932 connecting with a middle of the second channel 931. In a process of molding the product in the injection mold 200, the female mold 92 is mounted on the male mold 91 with the female core 922 engaged with the male core 912 to define a shaping chamber 94 therebetween communicated with bottoms of the slots 924. The ejection plate 93 is mounted on the female mold 92. The first channel 923, the second channel 931 and the slots 924 together define a runner 95. Then an injection feeder nose (not labeled) is inserted in the injection hole 932 to inject melted plastic materials into the runner 95 until the melted plastic materials flow into the shaping chamber 94. After cooling, the product is formed in the shaping chamber 94.

However, after the melted plastic materials injected in the injection mold 200 are cooled to form the product, there are some plastic materials remained in the slots 924 that results in a waste of the plastic materials and increases manufacturing cost of the product molded in the injection mold 200.

### SUMMARY OF THE INVENTION

An object of the present invention is to provide an injection mold for molding a product therein includes a male mold, a female mold, an ejection plate and an insert element. The male mold includes a male mold plate and a male core mounted in the male mold plate. The female mold includes a female mold plate and a female core. The female mold is engaged with the male mold with a bottom of the female core matched with a top of the male core to define a shaping chamber between the female core and the male core. The female mold plate defines a female receiving space concaved upward from a bottom thereof for receiving the female core therein, and a first insertion groove concaved downward from a top thereof and connecting with the female receiving space. The female core defines a first channel concaved downward from a top thereof, and a plurality of slots with tops thereof connecting with a bottom of the first channel and bottoms thereof penetrating through the bottom of the female core to connect with the shaping chamber. The ejection plate defines a second insertion groove vertically penetrating therethrough, and is mounted on the female mold with the second insertion groove corresponding to the first insertion groove. The insert element has a top thereof inserted into the second insertion groove and a bottom thereof stretched into the first insertion groove to cover the top of the female core and cooperate with the first channel and the slots to define a runner. The insert element defines a first injection groove vertically penetrating therethrough for receiving an injection feeder nose which is used to inject melted plastic materials into the runner. Then the melted plastic materials flow into the shaping chamber to mold the product in the shaping chamber.

As described above, the bottom of the insert element is inserted into the first insertion groove of the female plate to be mounted on the top of the female core which is received in the female receiving space. The female receiving space is located under the first insertion groove in the female plate to lower a height of the female core so as to lower length of the slots of the female core. So, the plastic materials are effectively saved to decrease manufacturing cost of the product molded in the shaping chamber of the injection mold.

### BRIEF DESCRIPTION OF THE DRAWINGS

The present invention will be apparent to those skilled in the art by reading the following description, with reference to the attached drawings, in which:

FIG. 1 is a sectional view of a conventional injection mold;

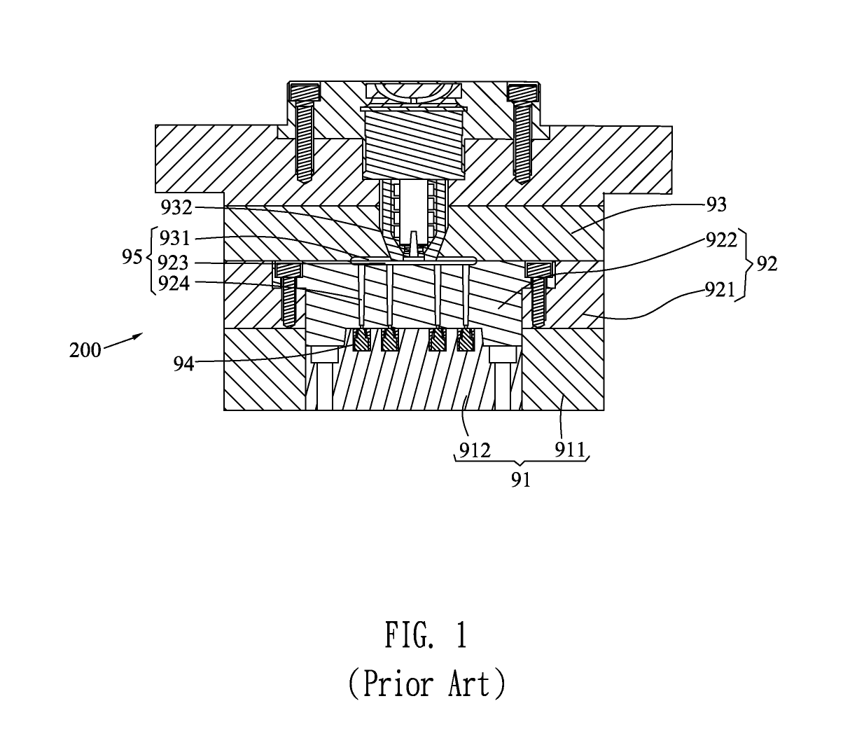

FIG. 2 is a sectional view of an injection mold in accordance to the present invention, wherein the injection mold is closed without melted plastic materials being injected into the injection mold;

FIG. 3 is an exploded view of the injection mold of FIG. 2; and

FIG. 4 is a sectional view of the injection mold of FIG. 2, wherein the injection mold is closed with the melted plastic materials being injected into the injection mold.

### DETAILED DESCRIPTION OF THE PREFERRED EMBODIMENT

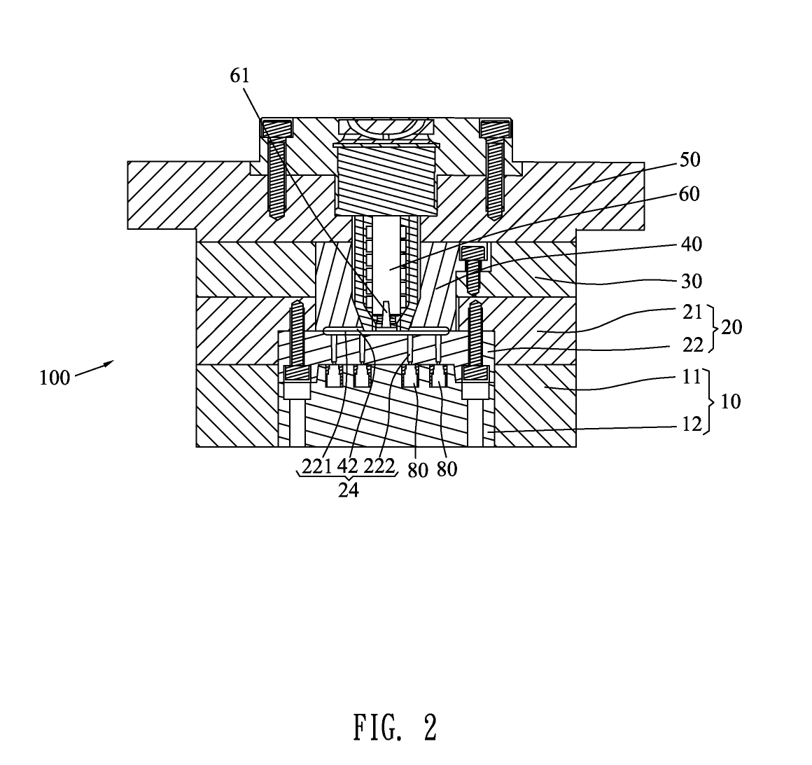

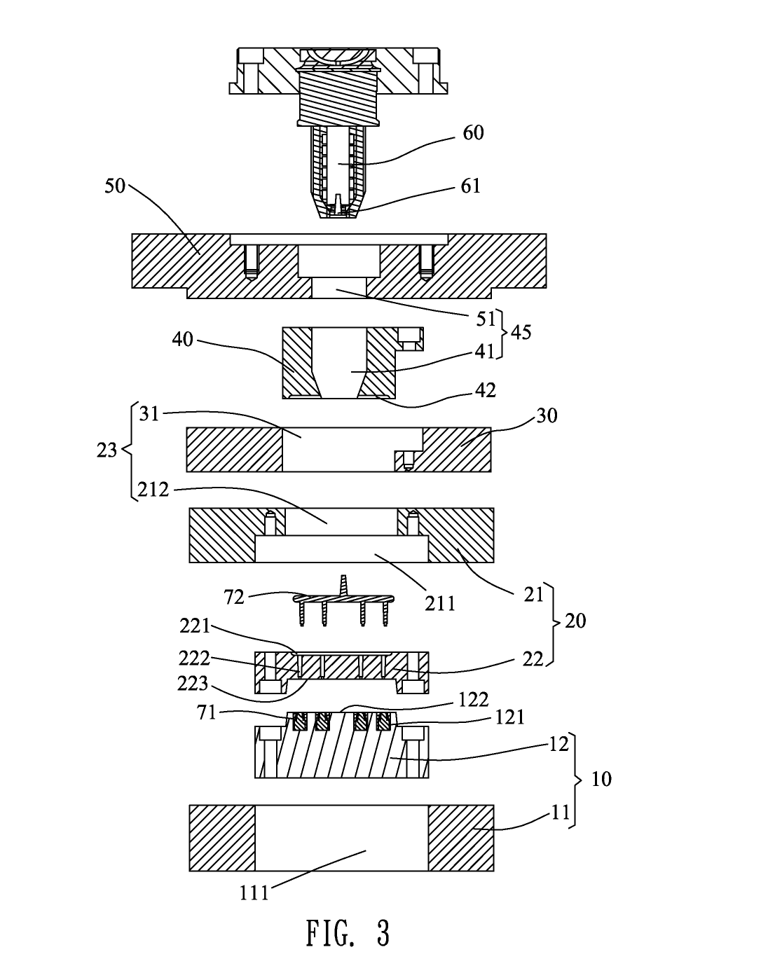

With reference to FIGS. 2-3, an injection mold 100 in accordance with the present invention is shown. The injection mold 100 adapted for molding a product 71 includes a male mold 10, a female mold 20, an ejection plate 30, an insert element 40 and a fastening plate 50.

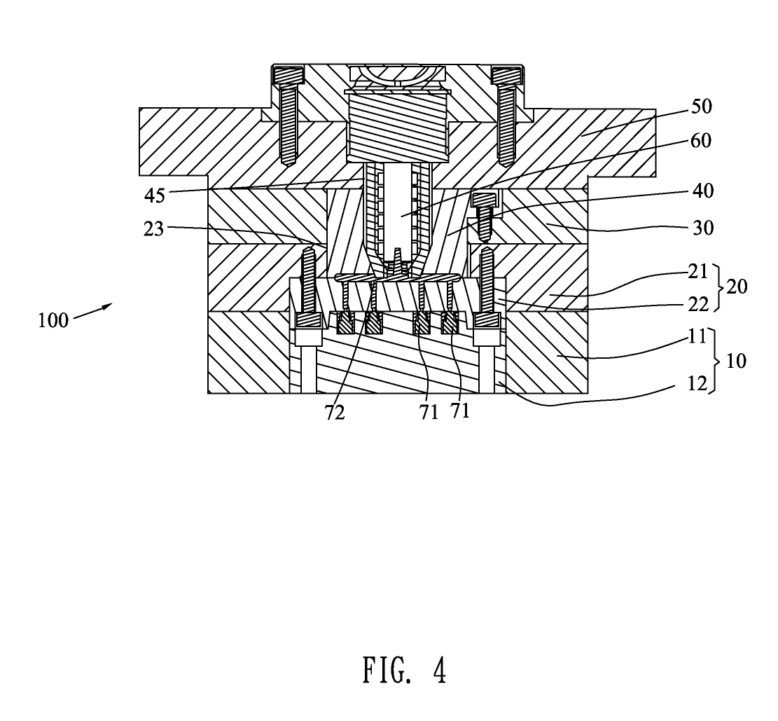

Referring to FIG. 2, FIG. 3 and FIG. 4, the male mold 10 includes a male mold plate 11 and a male core 12. A middle of the male mold plate 11 defines a male receiving space 111 vertically penetrating therethrough for receiving the male core 12 therein. A top surface of the male core 12 is acted as a male joint surface 122. A top of the male core 12 defines a plurality of grooves 121 extending vertically to penetrate through the male joint surface 121.

With reference to FIG. 2, FIG. 3 and FIG. 4, the female mold 20 includes a female mold plate 21 and a female core 22. A middle of a bottom of the female mold plate 21 is concaved upward to form a female receiving space 211 for receiving the female core 22 therein. A middle of a top of the female mold plate 21 is concaved downward to form a first insertion groove 212 connecting with a middle of a top of the female receiving space 211. A middle of a top of the female core 22 is concaved downward to form a first channel 221 narrower than the first insertion groove 212. A bottom surface of the female core 22 is acted as a female joint surface 223. The female core 22 defines a plurality of slots 222 with tops thereof connecting with a bottom of the first channel 221 and bottoms thereof penetrating through the female joint surface 223 of the female core 22. Quantity of the slots 222 of the female core 22 is the same as that of the grooves 121 of the male core 12.

With reference to FIG. 3, a middle of the ejection plate 30 defines a ladder-shaped second insertion groove 31 vertically penetrating therethrough with a bottom thereof narrower than a top thereof. The insert element 40 is of a ladder shape with a bottom thereof narrower than a top thereof. A middle of the insert element 40 defines a first injection groove 41 vertically penetrating therethrough. A bottom side of the insert element 40 is concaved upward to form a second channel 42 with a middle thereof connecting with the first injection groove 41. The second channel 42 is matched with the first channel 221. A middle of a bottom of the fastening plate 50 defines a T-shaped second injection groove 51 vertically penetrating therethrough.

Referring to FIG. 2, FIG. 3 and FIG. 4, in assembly, the female mold 20 moves downward towards the male mold 10 to be engaged with the male mold 10 with the female joint surface 223 of the female core 22 matched with the male joint surface 122 of the male core 12 to cover the grooves 121 of the male core 12 to define a shaping chamber 80 between the female core 22 and the male core 12. Meanwhile, the slots 222 of the female core 22 are connected with the grooves 121 of the male core 12. The ejection plate 30 is mounted on the female mold 20 with the bottom of the second insertion groove 31 corresponding to the first insertion groove 212. The first insertion groove 212 and the second insertion groove 31 together define an insertion groove 23 for receiving the insert element 40 therein. The top of the insert element 40 is inserted into the second insertion groove 31, and the bottom of the insert element 40 is stretched into the first insertion groove 212 to cover on the top of the female core 22 with the second channel 42 integrated with the first channel 221 and the slots 222 to define a runner 24. The fastening plate 50 is mounted on the ejection plate 30 and the insert element 40 with a bottom of the second injection groove 51 corresponding to the first injection groove 41. The first injection groove 41 and the second injection groove 51 together define an injection groove 45. An injection feeder nose 60 is mounted in the fastening plate 50 and inserted into the injection groove 45. A bottom of the injection feeder nose 60 has a feeder head 61 connecting with the second channel 42. Then the feeder head 61 of the injection feeder nose 60 injects melted plastic materials into the runner 24 and then the melted plastic materials flow into the shaping chamber 80. After cooling, the product 71 is formed in the shaping chamber 80 and a wasting portion 72 is formed in the runner 24 and the feeder head 61.

As described above, the insert element 40 is inserted in the insertion groove 23 of the injection mold 100 with the bottom of the insert element 40 inserted into the first insertion groove 212 of the female plate 21 to be mounted on the top of the female core 22 which is received in the female receiving space 211. The female receiving space 211 is located under the first insertion groove 212 in the female plate 21 to lower a height of the female core 22 so as to lower height of the slots 222 of the female core 22. So, the plastic materials are effectively saved to decrease manufacturing cost of the product 71 molded in the shaping chamber 80 of the injection mold 100.

What is claimed is:

1. An injection mold for molding a product therein, comprising:
a male mold including a male mold plate, and a male core mounted in the male mold plate;
a female mold including a female mold plate and a female core, the female mold being engaged with the male mold with a bottom of the female core matched with a top of the male core to define a shaping chamber between the female core and the male core, the female mold plate defining a female receiving space concaved upward from a bottom thereof for receiving the female core therein, and a first insertion groove concaved downward from a top thereof and connecting with the female receiving space, the female core defining a first channel concaved downward from a top thereof, and a plurality of slots with tops thereof connecting with a bottom of the first channel and bottoms thereof penetrating through the bottom of the female core to connect with the shaping chamber;
an ejection plate defining a second insertion groove vertically penetrating therethrough, and mounted on the female mold with the second insertion groove corresponding to the first insertion groove; and
an insert element having a top thereof inserted into the second insertion groove and a bottom thereof stretched into the first insertion groove to cover the top of the female core and cooperate with the first channel and the slots to define a runner, the insert element defining a first injection groove vertically penetrating therethrough for receiving an injection feeder nose which is used to inject melted plastic materials into the runner, then the melted plastic materials flowing into the shaping chamber to mold the product in the shaping chamber.

2. The injection mold as claimed in claim 1, wherein a top surface of the male core is acted as a male joint surface, the male core defines a plurality of grooves extending vertically to penetrate through the male joint surface, a bottom surface of the female core is acted as a female joint surface matched with the male joint surface to cover the grooves of the male core to define the shaping chamber between the female core and the male core.

3. The injection mold as claimed in claim 1, wherein a bottom side of the insert element is concaved upward to form a second channel connecting with the first injection groove and matched with the first channel.

4. The injection mold as claimed in claim 3, wherein the second channel, the first channel and the slots together define the runner.
